(19) United States
(12) Patent Application Publication
(10) Pub. No.: US 2026/0197455 A1
(43) Pub. Date: Jul. 9, 2026

(54) METHOD AND DEVICE FOR VIDEO CODING USING INTRA SUBDIVISION PREDICTION AND TRANSFORM SKIP

(71) Applicants: HYUNDAI MOTOR COMPANY, Seoul (KR); KIA CORPORATION, Seoul (KR); Research & Business Foundation SUNGKYUNKWAN UNIVERSITY, Suwon-si (KR)

(72) Inventors: Byeung Woo Jeon, Seongnam-si (KR); Jee Yoon Park, Seoul (KR); Yu Jin Lee, Suwon-si (KR); Jin Heo, Yongin-si (KR); Seung Wook Park, Yongin-si (KR)

(73) Assignees: HYUNDAI MOTOR COMPANY, Seoul (KR); KIA CORPORATION, Seoul (KR); Research & Business Foundation SUNGKYUNKWAN UNIVERSITY, Suwon-si (KR)

(21) Appl. No.: 19/130,871

(22) PCT Filed: Sep. 25, 2023
(86) PCT No.: PCT/KR2023/014607

§ 371 Date: May 16, 2025

(30) Foreign Application Priority Data
Nov. 22, 2022 (KR) 10-2022-0157432
Sep. 22, 2023 (KR) 10-2023-0126757

(51) Int. Cl. H04N 19/132; H04N 19/176

(52) U.S. Cl. CPC H04N 19/132; H04N 19/176

(57) ABSTRACT

A method and an apparatus for video coding use an intra sub-partitions prediction and a transform skip. An image decoding device divides a current block into subblocks and determines whether to apply transform skip is to the subblocks of the current block. When the transform skip is used, the image decoding device omits the inverse transform for the subblocks. When the transform skip is not used, the image decoding device determines a transform kernel for the subblocks and inversely transforms the subblocks by using the determined transform kernel.

### CROSS-REFERENCE TO RELATED APPLICATIONS

This is a U.S. national stage of International Application No. PCT/KR2023/014607 filed on Sep. 25, 2023 which claims priority to Korean Patent Application No. 10-2022-0157432 filed on Nov. 22, 2022, and Korean Patent Application No. 10-2023-0126757, filed on Sep. 22, 2023, the entire contents of each of which are incorporated herein by reference.

### TECHNICAL FIELD

The present disclosure relates to a video coding method and an apparatus that use an intra sub-partitions prediction and a transform skip.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

The intra prediction utilizes intra-picture pixel information to predict the pixel values of the current block to be encoded. The intra prediction may select one of multiple intra prediction modes, which is most suitable for the features of the picture, and may use the selected mode for predicting the current block. The encoder selects and uses one of the multiple intra prediction modes to encode the current block. The encoder may then pass information about the mode to the decoder.

HEVC technology utilizes a total of 35 intra-prediction modes for intra prediction, including 33 directional modes or angular modes with directionality and two non-directional modes or non-angular modes with no directionality. However, as the spatial resolution of the image increases from 720×480 to 2048×1024 or 8192×4096, the size of the prediction block unit is also increasing, which needs more intra-prediction modes to be added. As illustrated in FIG. 3A, the VVC technique uses 65 prediction modes that are further subdivided for intra-prediction, which allows for a greater variety of prediction directions compared to previous techniques.

In general, the image to be encoded is partitioned into Coding Units (CUs) of various shapes and sizes, and encoding thereof is performed by the unit of CU. At this time, the information specifying the partitioning is represented as a tree structure which is transmitted to the decoder to indicate which shapes and sizes of CUs the image is partitioned into. Meanwhile, when the image is partitioned into CUs and encoded by CU, all pixels in the CU block can be intra-predicted according to one prediction mode. At this time, when the reference samples used for intra prediction are distanced farther from the pixels in the CU block, the prediction efficiency decreases, and a lot of energy may remain in the residual signals obtained by the prediction. The remaining energy in the residual signals can be more severe if the block is a rectangular block elongated horizontally (or vertically) or if the block size is large. This becomes serious because some prediction directions would increase the distance between the pixels to be predicted and the reference samples. Subdividing the block into smaller CUs can be a solution to the matter. However, an increased overhead of transmitting the intra-prediction mode is introduced for each of the more subdivided CU blocks.

On the other hand, techniques exist to address the problem of increased overhead. In the existing technique, the CU block is sub-partitioned into smaller blocks of equal size, which are called ‘subblocks’, and intra prediction is performed for each subblock. By transmitting only one intra-prediction mode for the original CU block before sub-partitioning, and making the partitioned subblocks have a shared prediction mode, prediction efficiency can be increased while overhead is reduced. This prior art is referred to as the Intra Sub-Partitions (ISP) technique.

By using a transform technique, the residual signals are transformed into signals in the frequency domain. Depending on the transform, the energy in the block is concentrated in the low-frequency region, which may make it easier to encode the transformed residual signals. At this time, the encoder selects a transform technique such as Discrete Cosine Transform (DCT), Discrete Sine Transform (DST), and the like that is more suitable for the residual signals. The encoder uses the selected transform technique to transform the block to be encoded and communicates the information about the selected technique to the decoder.

According to HEVC technology, the residual signals of the luma channel are transformed into frequency signals by using a transform of Discrete Cosine Transform II (DCT-II) typically applied in the horizontal and vertical directions. To a block of size 4×4, quantization may be applied after the transform of Discrete Sine Transform VII (DST-VII) is applied, or after determining a transform skip mode that performs no transform on the residual signals. However, with the development of image compression technology, various methods of generating predicted signals have been developed, providing the residual signals generated by applying these methods with various characteristics. In recent VVC technology, new transforms such as DCT-VIII have been introduced to further diversify the transforms that can be applied to the residual signals. In addition, the transform of DST-VII and transform skip mode, which were only applied to 4×4 blocks, can be applied to blocks of other sizes.

However, the existing technology does not mind applying the transform skip mode to subblocks according to the application of the ISP technique. Therefore, to increase video coding efficiency and enhance video quality, there is a need to provide a method of efficiently correlating the transform skip mode with the subblocks predicted by the ISP technique.

### SUMMARY

The present disclosure seeks to provide a video coding method and an apparatus capable of applying the transform skip mode to subblocks predicted according to intra sub-partitions prediction (ISP prediction).

At least one aspect of the present disclosure provides a method of reconstructing a current block by a video decoding apparatus. The method includes partitioning the current block into subblocks based on a size of the current block and a subblock partitioning direction. The method also includes determining whether a transform skip is to be used on the subblocks of the current block. The method also includes checking whether the transform skip is used. The method further includes, when the transform skip is not used, determining a transform kernel for the subblocks.

Another aspect of the present disclosure provides a method of encoding a current block by a video encoding apparatus. The method includes partitioning the current block into subblocks based on a size of the current block and a subblock partitioning direction. The method also includes generating first quantized residual blocks by applying a transform skip and a quantization to residual blocks of the subblocks. The method also includes implicitly deriving a transform kernel or explicitly determining the transform kernel. The method also includes generating second quantized residual blocks by applying the transform kernel and the quantization to the residual blocks of the subblocks.

Yet another aspect of the present disclosure provides a computer-readable recording medium storing a bitstream generated by a video encoding method. The video encoding method includes partitioning a current block into subblocks based on a size of the current block and a subblock partitioning direction. The video encoding method also includes generating first quantized residual blocks by applying a transform skip and a quantization to residual blocks of the subblocks. The video encoding method also implicitly deriving a transform kernel or explicitly determining the transform kernel. The video encoding method also generating second quantized residual blocks by applying the transform kernel and the quantization to the residual blocks of the subblocks.

As described above, the present disclosure provides a video coding method and an apparatus capable of applying the transform skip mode to subblocks predicted according to intra sub-partitions prediction. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating rate-distortion estimation for determining prediction and transform.

FIG. 7 is a diagram illustrating the proportion of coding units (CUs) using new reference samples among CUs using intra sub-partitions (ISPs).

FIG. 8 is a diagram illustrating rate-distortion estimation for determining prediction and transform, according to at least one embodiment of the present disclosure.

FIG. 9 is a diagram illustrating the use of transform skip and multiple transform selection (MTS) for blocks with ISP applied, according to at least one embodiment of the present disclosure.

FIG. 10 is a flowchart of a method of encoding the current block by a video encoding apparatus, according to at least one embodiment of the present disclosure.

FIG. 11 is a flowchart of a method of reconstructing the current block by a video decoding apparatus, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

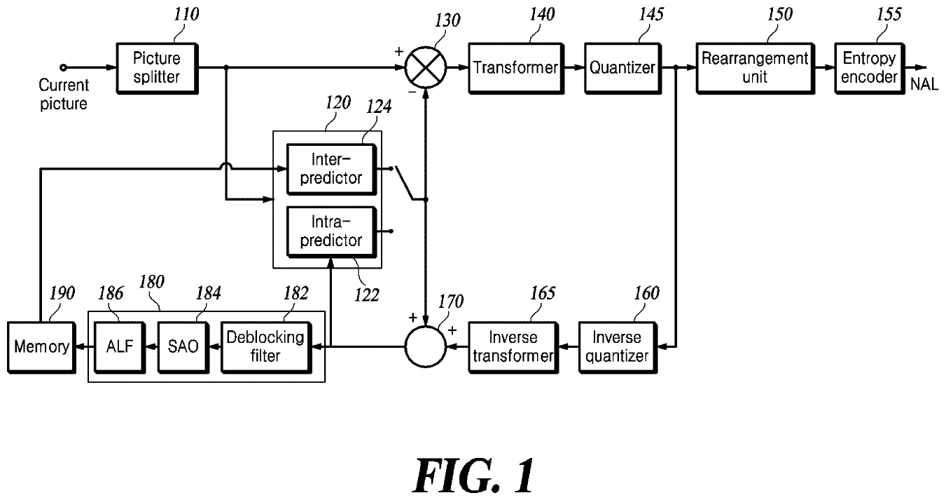

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

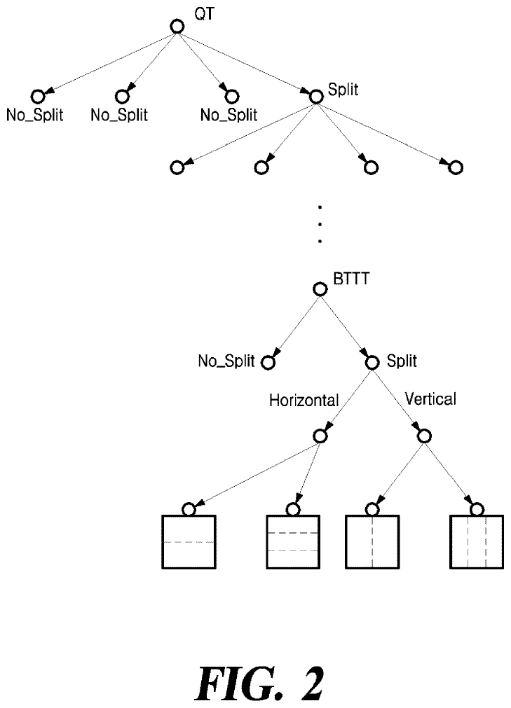

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

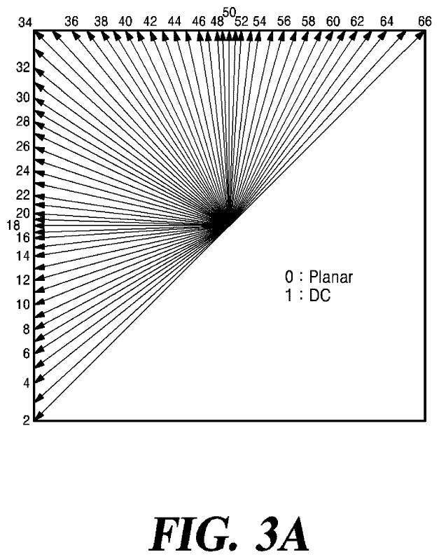

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

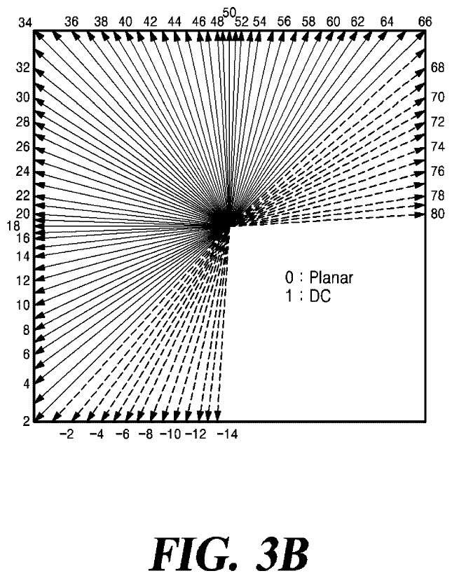

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

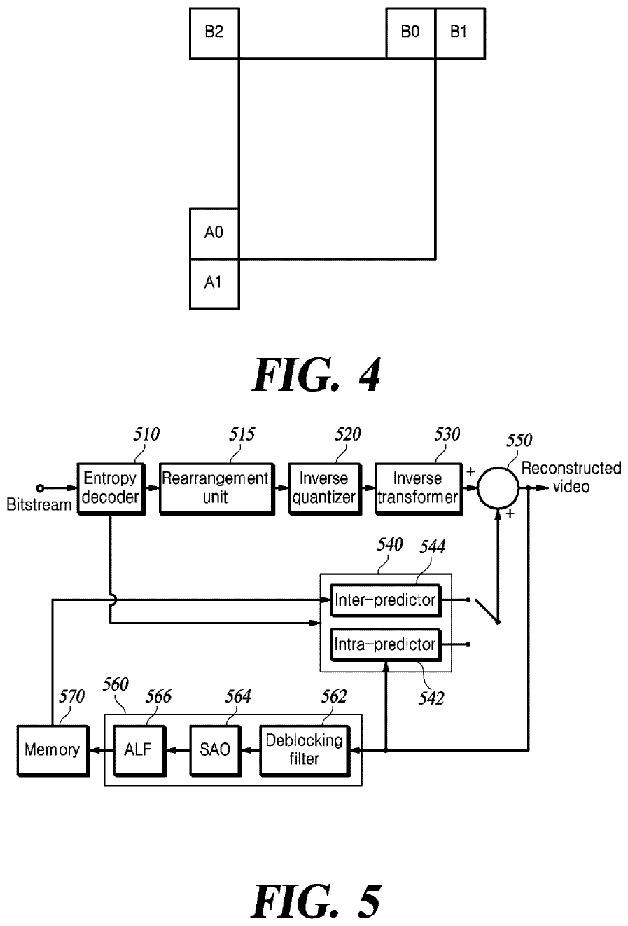

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform function or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus capable of applying the transform skip mode to subblocks predicted according to the intra sub-partitions (ISP) prediction technique.

The following embodiments may be performed by the intra predictor 122, transformer 140, and inverse transformer 165 in the video encoding device. The following embodiments may also be performed by inverse transformer 530 and intra predictor 542 in the video decoding device.

The video encoding device in encoding the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the decoding of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

### I. Intra Prediction and Intra Sub-Partitions (ISP)

In the VVC technique, the intra-prediction mode of the luma block has subdivided directional modes (i.e., modes −14 to 80) in addition to non-directional modes (i.e., planar and DC modes), as illustrated in FIGS. 3A and 3B. Based on these prediction modes, several techniques exist to increase the coding efficiency of intra prediction. The ISP technique sub-partitions the current block into smaller blocks of the same size, and then allows the intra-prediction mode to be shared across the subblocks, but applies a transform to each of the subblocks. The sub-partitioning of the block may be performed in either a horizontal or vertical direction.

In the following description, the large block before sub-partitioning is referred to as the current block, and each of the smaller blocks resulting from sub-partitioning is referred to as a subblock.

The operation of the ISP technology is as follows.

The video encoding apparatus signals to the video decoding apparatus the intra_subpartitions_mode_flag indicating whether ISP is to be applied and the intra_subpartitions_split_flag indicating the sub-partitioning method, as shown in Table 1.

```
TABLE 1
coding_unit( x0, y0, cbWidth, cbHeight, cqtDepth, treeType, modeType ) {
...
  if( sps_isp_enabled_flag && intra_luma_ref_idx = = 0 &&
    ( cbWidth <= MaxTbSizeY && cbHeight <= MaxTbSizeY ) &&
    ( cbWidth * cbHeight > MinTbSizeY * MinTbSizeY ) && !cu_act_enabled_flag )
    intra_subpartitions_mode_flag
  if( intra_subpartitions_mode_flag = = 1 )
    intra_subpartitions_split_flag
...
```

The sub-partition types, IntraSubPartitionsSplitType according to intra_subpartitions_mode_flag and intra_subpartitions_split_flag are shown in Table 2.

TABLE 2

| IntraSubPartitionsSplitType | Name of IntraSubPartitionsSplitType |
|---|---|
| 0 | ISP_NO_SPLIT |
| 1 | ISP_HOR_SPLIT |
| 2 | ISP_VER_SPLIT |

The ISP technology sets the partition types, IntraSubPartitionsSplitType as follows.

If intra_subpartitions_mode_flag is 0, IntraSubPartitionsSplitType is set to 0 and no subblock partitioning is performed. Namely, no ISP is applied.

If intra_subpartitions_mode_flag is not 0, ISP is applied. In this case, IntraSubPartitionsSplitType is set to the value of 1+intra_subpartitions_split_flag, and subblock partitioning is performed according to the partition type. If IntraSubPartitionsSplitType=1, a subblock partition (ISP_HOR_SPLIT) is performed in the horizontal direction, and if IntraSubPartitionsSplitType=2, a subblock partition (ISP_VER_SPLIT) is performed in the vertical direction. This means that the intra_subpartitions_split_flag may indicate the subblock partition direction.

For example, if the ISP mode of horizontal sub-partitioning is applied to the current block, IntraSubPartitionsSplitType is 1, intra_subpartitions_mode_flag is 1, and intra_subpartitions_split_flag is 0.

In the following description, intra_subpartitions_mode_flag is expressed as a subblock partition application flag, intra_subpartitions_split_flag as a subblock partition direction flag, and IntraSubPartitionsSplitType as a subblock partition type.

In addition, ISP_HOR_SPLIT is used interchangeably with horizontal partitioning and ISP_VER_SPLIT is used interchangeably with vertical partitioning.

The current block may be sub-partitioned in either the horizontal or vertical direction, but if the size of the current block is too small, the coding efficiency of the subblock resulting from the sub-partitioning may be further reduced, or the subblock may become smaller than the minimum transform unit, making it impossible to transform the subblock. To prevent this from happening, the application of ISP may be restricted by reference to the size of the subblock obtained by partitioning. For example, the current block may be sub-partitioned to prevent the number of pixels in the partitioned subblock from becoming smaller than 16. For example, if the current block is 4×4 in size, ISP is not applied. A block with a size of 4×8 or 8×4 may be partitioned into two subblocks of the same shape and size, which is a partitioning called Half_Split. A block of any other size may be partitioned into four subblocks of the same shape and size, which is a partitioning called Quarter_Split.

The video encoding apparatus sequentially encodes the subblocks in a left-to-right or top-to-bottom order. The respective subblocks share the same intra-prediction information. In the intra prediction for encoding the respective subblocks, the video encoding apparatus may improve the compression efficiency by utilizing the reconstructed pixels in the earlier encoded subblock as the predicted pixel values of the subsequent subblock.

### II. Transform Skip Technique

When encoding/decoding an image, a transform is usually performed, but in some cases, it may be advantageous not to perform a transform. Omitting from performing a transform is referred to as a transform skip technique. In addition, encoding information indicating whether the transform is to be skipped for the current block is represented by a transform skip flag or transform_skip_flag. The transform_skip_flag is marked on the bitstream and transmitted from the video encoding apparatus to the video decoding apparatus. The video decoding apparatus parses the transform_skip_flag from the bitstream. If transform_skip_flag=0, the video decoding apparatus performs a transform, and if transform_skip_flag=1, the video decoding apparatus may omit the transform and perform the decoding process of the current block.

In the prior art, the video encoding apparatus signals transform_skip_flag[x][y][compID], as shown in Table 3

TABLE 3
[TU level]

```
transform_unit( x0, y0, tbWidth, tbHeight, treeType, subTuIndex, chType )
...
  if( tu_y_coded_flag[ x0 ][ y0 ] && treeType != DUAL_TREE_CHROMA ) {
    if( sps_transform_skip_enabled_flag && !BdpcmFlag[ x0 ][ y0 ][ 0 ] &&
        tbWidth <= MaxTsSize && tbHeight <= MaxTsSize &&
        ( IntraSubPartitionsSplitType = = ISP_NO_SPLIT ) && !cu_sbt_flag )
      transform_skip_flag[ x0 ][ y0 ][ 0 ]
...
  if( tu_cb_coded_flag[ xC ][ yC ] && treeType != DUAL_TREE_LUMA ) {
    if( sps_transform_skip_enabled_flag && !BdpcmFlag[ x0 ][ y0 ][ 1 ] &&
        wC <= MaxTsSize && hC <= MaxTsSize && !cu_sbt_flag )
      transform_skip_flag[ xC ][ yC ][ 1 ]
    if( !transform_skip_flag[ xC ][ yC ][ 1 ] | | sh_ts_residual_coding_disabled_flag )
      residual_coding( xC, yC, Log2( wC ), Log2( hC ), 1 )
    else
      residual_ts_coding( xC, yC, Log2( wC ), Log2( hC ), 1 )
  }
  if( tu_cr_coded_flag[ xC ][ yC ] && treeType != DUAL_TREE_LUMA &&
      !( tu_cb_coded_flag[ xC ][ yC ] && tu_joint_cbcr_residual_flag[ xC ][ yC ] ) ) {
    if( sps_transform_skip_enabled_flag && !BdpcmFlag[ x0 ][ y0 ][ 2 ] &&
        wC <= MaxTsSize && hC <= MaxTsSize && !cu_sbt_flag )
      transform_skip_flag[ xC ][ yC ][ 2 ]
...
```

Here, for each channel, x, y represent the coordinates of the top-left pixel of the residual block. compID indicates the channel. For example, if compID=0, compID indicates the luma component, if compID=1, compID indicates the Cb component, and if compID=2, compID indicates the Cr component. When transform skip is not used (i.e., transform_skip_flag=0), in the prior art, the video encoding apparatus transfers mts_idx to the video decoding apparatus as shown in Table 4 to signal the transform kernel applied to the transform of the current block.

TABLE 4
coding_unit( x0, y0, cbWidth, cbHeight, cqtDepth, treeType, modeType ) {
...
if( treeType != DUAL_TREE_CHROMA && lfnst_idx = = 0 &&

| | |
|---|---|
| transform_skip_flag[ x0 ][ y0 ][ 0 ] = = 0 && Max( cbWidth, cbHeight ) <= 32 | && |
| IntraSubPartitionsSplitType = = ISP_NO_SPLIT && cu_sbt_flag = = 0 | && |

```
    MtsZeroOutSigCoeffFlag = = 1 && MtsDcOnly = = 0 ) {
    if( ( ( CuPredMode[ chType ][ x0 ][ y0 ] = = MODE_INTER &&
        sps_explicit_mts_inter_enabled_flag ) | |
        ( CuPredMode[ chType ][ x0 ][ y0 ] = = MODE_INTRA &&
        sps_explicit_mts_intra_enabled_flag ) ) )
      mts_idx
...
```

### III. Prior Art's Deficiency and Embodiments of the Present Disclosure

The prior art is not capable of utilizing the two techniques of ISP and transform skip together. In the prior art, blocks that use transform skip cannot benefit from prediction according to the ISP technique, resulting in inefficiency.

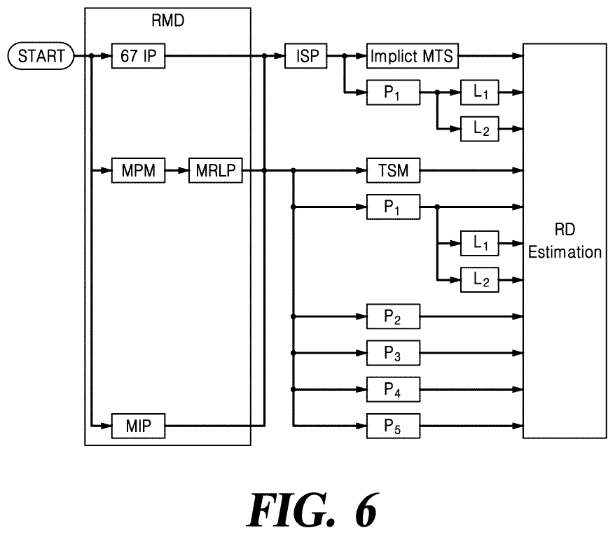

FIG. 6 is a diagram illustrating rate-distortion estimation for determining prediction and transform.

FIG. 6 illustrates several cases in which a video encoding apparatus according to the prior art performs rate-distortion estimation to determine how to predict and transform. In the example of FIG. 6, the transform skip is not tested for blocks where the ISP is performed. In the example of FIG. 6, there are illustrated Rough Mode Decision (RMD), Most Probable Mode (MPM), Multiple Reference Line Prediction (MRLP), Matrix-weighted Intra Prediction (MIP), and Transform Skip Mode (TSM). Pi (i=1, 2, 3, 4, 5) denotes the primary transform kernel, and Li (i=1, 2) denotes the Low Frequency Non-separable Transform (LFNST) kernel for the secondary transform.

In the following, in terms of each of ISP (Intra Sub-Partitions) and transform skip, the prior art can be analyzed as follows.

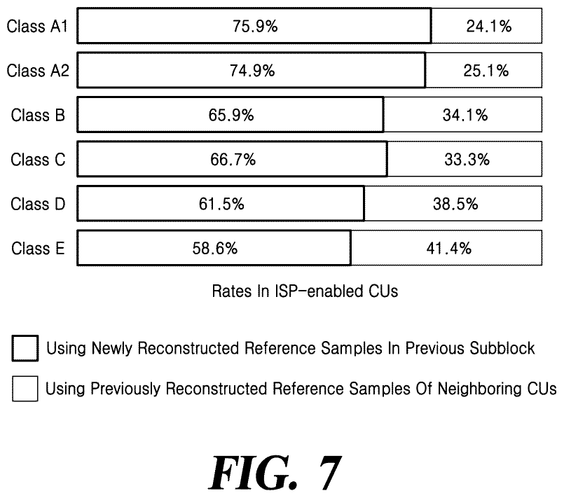

The first to describe is the relationship between the performance of ISP and transform. In general, the performance improvement with ISP can be attributed to the fact that when a block is partitioned into multiple subblocks, newly reconstructed reference samples, i.e., reconstructed samples from the previous subblock, located closer to each subblock can be used for prediction. However, the above are only some of the factors that contribute to performance improvement with ISP. Given that the additional two bits are used, i.e., the subblock partition application flag and the subblock partitioning direction flag are used, if the performance improvement with ISP is mainly due to the increase in prediction accuracy with subblock-wise prediction, then most CUs using ISP need to use newly reconstructed reference samples. According to the example in FIG. 7, depending on the video group, up to 41.4% of the CUs using ISP use for prediction the earlier reconstructed reference samples than new reference samples of neighboring CUs, i.e., use the same reference samples as those without using ISP. In the example of FIG. 7, Class represents a group of videos used in the experiment. The example of FIG. 7 exhibits that the subblock-wise transform has a significant impact on the performance of the ISP.

Furthermore, from the results of applying transforms to the ISP-enabled CUs on which ISP is used, one can expect that prediction performance would be further improved if transform skips were used for subblocks. Table 5 shows the distribution of coded block flags (CBFs) in CUs with ISPs by video group.

TABLE 5

| | | | | | | |
|---|---|---|---|---|---|---|
| Video class | A1 | A2 | B | C | D | E |

Quad Split

| | | | | | | |
|---|---|---|---|---|---|---|
| All “CBF = 1” | 25% | 17% | 25% | 35% | 38% | 21% |
| “CBF = 0” exist | 75% | 83% | 75% | 65% | 62% | 79% |

Half Split

| | | | | | | |
|---|---|---|---|---|---|---|
| All “CBF = 1” | 37% | 32.0% | 45% | 57% | 61% | 40% |
| “CBF = 0” exist | 63% | 68.0% | 55% | 43% | 39% | 60% |

Here, ‘All “CBF=1”’ indicates that all subblocks in the CU have CBF=1. Namely, all subblocks have a non-zero transform coefficient. “‘CBF=0” exist’ indicates that at least one subblock in the CU has CBF=0. Namely, at least one subblock has a transform coefficient of zero. In this case, CBF=0 indicates that the prediction is well performed and there are no non-zero transform coefficients in that block. For CUs with CBF=0, no encoding of the residual signals is performed. Depending on the video group, up to 38% of CUs with Quarter_Split have a CBF of 1 for all subblocks within that CU. Up to 61% of CUs with Half_Split have a CBF of 1 for all subblocks within that CU. These results show that ISPs are selected in those CUs even though the prediction is not performed well. Therefore, it is expected that encoding performance can be improved by using transform skip when energy compaction is hardly achieved in subblocks with non-zero transform coefficients.

The following describes benefits in terms of applications of transform skip.

Transform skip avoids performing the entire transform process when effective energy compaction cannot be performed following the transform of the residual signals, such as screen content. This means that transform skip represents applying a transform kernel in the form of an identity matrix to the residual signals. After a transform skip is performed, the residual signals remain unchanged. The percentage of CUs using transform skip according to video groups may be expressed as shown in Table 6.

TABLE 6

| | | Probability of using |
|---|---|---|
| category | sequence | Transform Skip |
| Class F | ArenaOfValor | 9% |
| | BasketballDrillText | 11% |
| | SlideEditing | 55% |
| | SlideShow | 36% |
| TGM 1080P | sc_flyingGraphics_1920 × 1080 | 33% |
| YCbCr444 | sc_desktop_1920 × 1080 | 28% |
| | sc_console_1920 × 1080 | 27% |
| | ChineseEditing_1920 × 1080 | 38% |
| TGM 720P | sc_web_browsing_1280 × 720 | 28% |
| YCbCr444 | sc_map_1280 × 720 | 22% |
| | sc_programming_1280x720 | 36% |
| | sc_SlideShow_1280 × 720 | 31% |
| Animation | ArenaOfValor_1920 × 1080 | 9% |
| YCbCr444 | sc_robot_1280 × 720 | 4% |
| | Glasshalf_3840 × 2160 | 20% |
| Mixed | Basketball_Screen_2560 × 1440 | 30% |
| Content | MissionControlClip2_2560 × 1440 | 33% |
| YCbCr444 | MissionControlClip3_1920 × 1080 | 29% |

According to Table 6, transform skip is used at a rate of 55% in SlideEditing of Class F which is a screen content video, and is used at a similarly large rate in other screen content videos. If blocks with transform skip can utilize ISP technology, it is expected that up to half of the blocks in a video group can improve prediction performance by applying ISP. However, existing techniques cannot realize the linkage between transform skip and ISP techniques.

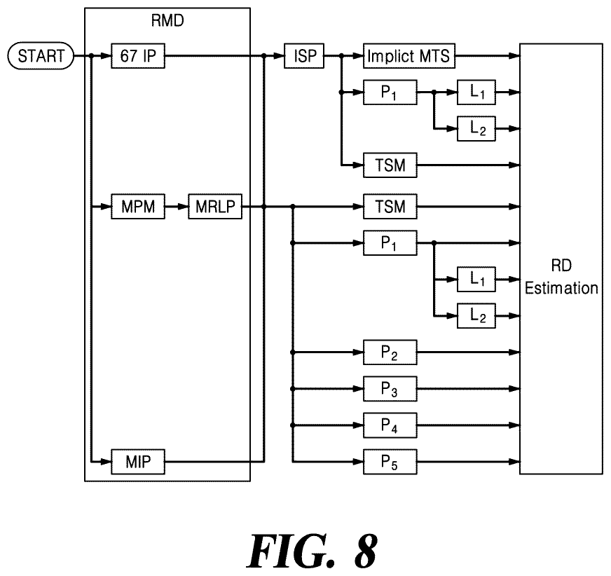

FIG. 8 is a diagram illustrating rate-distortion estimation for determining prediction and transform, according to at least one embodiment of the present disclosure.

The problems of the prior art described above can be addressed by allowing the ISP to be used even in blocks on which transform skip is used. Alternatively, the problems of the prior art can be addressed by allowing transform skip to be used in blocks that are partitioned into subblocks and on which ISP is used. For example, as illustrated in FIG. 8, transform skip may be used to determine a transform for an ISP-enabled block, and the use or non-use of transform skip may be further tested during encoding. In this case, whether the transform skip is to be used may be determined equally for all subblocks within the current block, or whether the transform skip is to be used may be determined independently for each subblock.

Additionally, for blocks on which ISP is used, the use of explicit Multiple Transform Selection (MTS) may be implemented in addition to transform skip. In this case, the same transform kernel determined by the explicit MTS may be used for all subblocks within the current block, or the transform kernel may be determined by the explicit MTS for each subblock. For example, for the ISP-enabled block, only transform skip may be used, transform skip or implicit MTS may be used, or transform skip or explicit MTS may be used. Each of the cases described above may be common to all subblocks within the current block or may be applied to each subblock.

Here, explicit MTS refers to a method of determining which transform kernel to use through the video encoding apparatus signaling an MTS indicator to the video decoding apparatus. The implicit MTS refers to a method of deriving the transform kernel based on the prediction mode, the size of the transform unit, and the like.

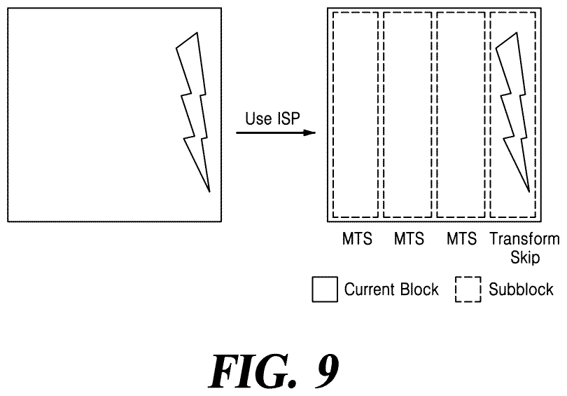

FIG. 9 is a diagram illustrating the use of transform skip and MTS (multiple transform selection) for blocks with ISP applied, according to at least one embodiment of the present disclosure.

When there are residual signals within the current block, such as within the block illustrated in FIG. 9, if the ISP was used for prediction, the transform may be performed for each subblock. Therefore, by applying the solution of the present disclosure, the transform method can be determined per subblock. For example, the rightmost subblock may use transform skip, and the other subblocks may use MTS. Additionally, the present disclosure can implement a method of using both ISP and transform skip if transform skip is enabled at a high level.

The following presents preferred implementations that address the prior art deficiencies described above.

The following embodiments are described centering about the video encoding apparatus but may be implemented in the same or similar manner by the video decoding apparatus.

<Implementation 1> Determining Whether Transform Skip is to be Used and a Transform Kernel for a Subblock within the ISP-Enabled Current Block

In this implementation, the video encoding apparatus may use transform skip and ISP combined by determining whether transform skip is to be used and a transform kernel for each of the subblocks within the ISP-enabled current block. In this case, the subblocks within the current block may (1) use transform skip or implicit MTS, or (2) use transform skip or explicit MTS.

In this implementation, whether the transform skip is to be used and the transform kernel may (Implementation 1-1) be determined equally for all subblocks within the current block or may (Implementation 1-2) be determined on a per-subblock basis.

### <Implementation 1-1> Equally Determining Whether Transform Skip is to be Used and Transform Kernel for all Subblocks

In this implementation, to use transform skip and ISP together, the video encoding apparatus may equally determine whether transform skip is to be used and the transform kernel for all subblocks within the ISP-enabled current block. Namely, the type of transform used or whether transform skip is to be used may be shared, similar to how all subblocks within the ISP-enabled current block share a prediction mode. In this case, subblocks in the current block may (Implementation 1-1-1) use either transform skip or implicit MTS, or (Implementation 1-1-2) use either transform skip or explicit MTS.

### <Implementation 1-1-1> When Using Either Transform Skip or Implicit MTS

In this implementation, the video encoding apparatus equally determines whether transform skip is to be used for all subblocks within the ISP-enabled current block. Namely, if transform skip is used in the ISP-enabled current block, transform skip is applied to all subblocks within the current block. With transform skip indicating that no transform is performed, this implementation produces the same result as transform skip being applied to the entire current block. If transform skip is not used in the ISP-enabled current block, the respective subblocks within the current block perform a transform according to the implicit MTS.

In this implementation, the video encoding apparatus signals a flag indicating whether transform skip is to be used to signal the use or non-use thereof. Example syntaxes with an improvement over the prior art regarding the transmission of the flag are shown in Table 7.

```
TABLE 7
transform_unit( x0, y0, tbWidth, tbHeight, treeType, subTuIndex, chType )
...
  if( tu_y_coded_flag[ x0 ][ y0 ] && treeType != DUAL_TREE_CHROMA ) {
    if( sps_transform_skip_enabled_flag && !BdpcmFlag[ x0 ][ y0 ][ 0 ] &&
        tbWidth <= MaxTsSize && tbHeight <= MaxTsSize &&
        !cu_sbt_flag )
      transform_skip_flag[ x0 ][ y0 ][ 0 ]
...
```

In Table 7, even when ISP is used, i.e., when IntraSubPartitionsSplitType is ISP_HOR_SPLIT or ISP_VER_SPLIT, the transform_skip_flag may be signaled to indicate whether transform skip is to be used.

### <Implementation 1-1-2> When Using Either Transform Skip or Explicit MTS

In this embodiment, the video encoding apparatus equally determines whether transform skip is to be used for all subblocks within the ISP-enabled current block. Namely, if transform skip is used in the ISP-enabled current block, transform skip is applied to all subblocks within the current block. With transform skip indicating that no transform is performed, this implementation produces the same result as transform skip being applied to the entire current block. If transform skip is not used in the ISP-enabled current block, the respective subblocks within the current block perform a transform according to the explicit MTS.

In this implementation, the video encoding apparatus signals a flag indicating whether transform skip is to be used to signal the use or non-use thereof. Example syntaxes with an improvement over the prior art regarding signaling the flag are shown in Table 8.

```
TABLE 8
transform_unit( x0, y0, tbWidth, tbHeight, treeType, subTuIndex, chType )
...
  if( tu_y_coded_flag[ x0 ][ y0 ] && treeType != DUAL_TREE_CHROMA ) {
    if( sps_transform_skip_enabled_flag && !BdpcmFlag[ x0 ][ y0 ][ 0 ] &&
        tbWidth <= MaxTsSize && tbHeight <= MaxTsSize &&
        !cu_sbt_flag )
      transform_skip_flag[ x0 ][ y0 ][ 0 ]
...
```

In Table 8, even when ISP is used, i.e., when IntraSubPartitionsSplitType is ISP_HOR_SPLIT or ISP_VER_SPLIT, a transform_skip_flag may be signaled indicating whether transform skip is to be enabled. In addition, when signaling that transform_skip_flag=0 is made, the video encoding apparatus may signal mts_idx to signal the MTS transform kernel. Example syntaxes with an improvement over the prior art regarding signaling the MTS transform kernel are shown in Table 9.

```
TABLE 9
coding_unit( x0, y0, cbWidth, cbHeight, cqtDepth, treeType, modeType ) {
...
  if( treeType != DUAL_TREE_CHROMA && lfnst_idx = = 0 &&
    transform_skip_flag[ x0 ][ y0 ][ 0 ] = = 0 && Max( cbWidth, cbHeight ) <= 32 &&
    cu_sbt_flag = = 0 &&
    MtsZeroOutSigCoeffFlag = = 1 && MtsDcOnly = = 0 ) {
      if( ( ( CuPredMode[ chType ][ x0 ][ y0 ] = = MODE_INTER &&
          sps_explicit_mts_inter_enabled_flag ) | |
          ( CuPredMode[ chType ][ x0 ][ y0 ] = = MODE_INTRA &&
          sps_explicit_mts_intra_enabled_flag ) ) )
        mts_idx
...
```

### <Implementation 1-2> Determining Whether Transform Skip is to be Used and Transform Kernel on a Per-Subblock Basis

In this implementation, for the use of an ISP along, the video encoding apparatus may determine on a per-subblock basis whether transform skip is to be used and the transform kernel for the ISP-enabled current block. Each of the subblocks within the current block may (Implementation 1-2-1) use either transform skip or implicit MTS, or (Implementation 1-2-2) use either transform skip or explicit MTS.

### <Implementation 1-2-1> When Using Either Transform Skip or Implicit MTS

In this implementation, the video encoding apparatus may determine on a per-subblock basis whether transform skip is to be used for the ISP-enabled current block. The transform skip may be applied to a subblock where transform skip is determined to be enabled, and to a subblock where transform skip is determined to be disabled, the transform may be applied according to the implicit MTS.

In this implementation, the video encoding apparatus signals a flag indicating whether transform skip is to be used to signal the use or non-use of the transform skip on a per-subblock basis. Example syntaxes with an improvement over the prior art regarding the transmission of the flag are shown in Table 10.

```
TABLE 10
transform_unit( x0, y0, tbWidth, tbHeight, treeType, subTuIndex, chType )
...
  if( tu_y_coded_flag[ x0 ][ y0 ] && treeType != DUAL_TREE_CHROMA ) {
    if( sps_transform_skip_enabled_flag && !BdpcmFlag[ x0 ][ y0 ][ 0 ] &&
        tbWidth <= MaxTsSize && tbHeight <= MaxTsSize &&
        ( IntraSubPartitionsSplitType = = ISP_NO_SPLIT ) && !cu_sbt_flag )
      transform_skip_flag[ x0 ][ y0 ][ 0 ]
    if(sps_transform_skip_enabled_flag &&
          IntraSubPartitionsSplitType ! = ISP_NO_SPLIT )
      transform_skip_subpartitions[ x0 ][ y0 ][ 0 ]
...
```

The video encoding apparatus signals a transform_skip_flag indicating whether transform skip is to be enabled for the ISP-disabled current block, and it signals transform_skip_subpartitions indicating whether transform skip is to be enabled on a per-subblock basis for the ISP-enabled current block. transform_skip_subpartitions may be an array of 0 or 1 as many as subblocks, indicating whether transform skip is to be used for each subblock in the ISP-enabled current block. Alternatively, transform_skip_subpartitions may be an index indicating one of the sets containing whether transform skip is to be enabled or disabled per subblock.

An example assumes that four subblocks are present within the ISP-enabled current block, and transform_skip_subpartitions is the array. For example, if transform_skip_subpartitions is signaled as 0001, transform skip may be used for the rightmost subblock, as shown in the example in FIG. 9. Whether each number in the array is a flag representing which subblock may be determined by an arrangement between the video encoding apparatus and the video decoding apparatus. Yet another example assumes that four subblocks are present within the ISP-enabled current block, and transform_skip_subpartitions is the index. For example, if the values represented by transform_skip_subpartitions are defined as shown in Table 11, and transform_skip_subpartitions is signaled as 0, then transform skip may be used for the rightmost subblock, as shown in the example of FIG. 9. Whether each number in the set indicated by the index is a flag representing which subblock may be determined by an arrangement between the video encoding apparatus and the video decoding apparatus.

TABLE 11

| transform_skip_subpartitions | Using Transform Skip per subblock |
|---|---|
| 0 | (0, 0, 0, 1) |
| 1 | (0, 1, 0, 1) |
| 2 | (0, 0, 1, 1) |
| . . . | . . . |

### <Implementation 1-2-2> When Using Either Transform Skip or Explicit MTS

In this embodiment, the video encoding apparatus may determine on a per-subblock basis whether transform skip is to be used for the ISP-enabled current block. The transform skip may be applied to a subblock where the use of transform skip is determined, and to a subblock where the non-use of transform skip is determined, the transform may be applied according to the explicit MTS.

In this implementation, the video encoding apparatus signals a flag indicating whether transform skip is to be used to signal on a per-subblock basis whether transform skip is to be enabled. Example syntaxes with an improvement over the prior art regarding the transmission of the flag are shown in Table 12.

```
TABLE 12
transform_unit( x0, y0, tbWidth, tbHeight, treeType, subTuIndex, chType )
...
  if( tu_y_coded_flag[ x0 ][ y0 ] && treeType != DUAL_TREE_CHROMA ) {
    if( sps_transform_skip_enabled_flag && !BdpcmFlag[ x0 ][ y0 ][ 0 ] &&
        tbWidth <= MaxTsSize && tbHeight <= MaxTsSize &&
        ( IntraSubPartitionsSplitType = = ISP_NO_SPLIT ) && !cu_sbt_flag )
      transform_skip_flag[ x0 ][ y0 ][ 0 ]
    if(sps_transform_skip_enabled_flag &&
          IntraSubPartitionsSplitType ! = ISP_NO_SPLIT )
      transform_skip_subpartitions[ x0 ][ y0 ][ 0 ]
...
```

The video encoding apparatus signals transform_skip_flag that indicates whether transform skip is to be used for the ISP-disabled current block, and performs transform_skip_subpartitions to signal on a per-subblock basis whether transform skip is to be used for the ISP-enabled current block. In Table 12, transform_skip_subpartitions behaves like a process. Namely, by performing transform_skip_subpartitions, the video encoding apparatus may signal transform_skip_subpartition_flag which is a flag indicating whether transform skip is to be used on a per-subblock basis. If transform_skip_subpartition_flag is 1, transform skip is applied to the relevant subblock. Whereas if transform_skip_subpartition_flag is 0, the video encoding apparatus may further signal mts_idx to convey the type of MTS transform kernel. The above process may be repeated for all subblocks within the ISP-enabled current block. Based on the transform_skip_subpartitions described above, a pseudo code representing the signaling of the syntax for each subblock in terms of the video encoding apparatus is shown in Table 13.

TABLE 13
Signal a flag (transform_skip_subpartition_flag) indicating whether the current
subblock is to use tansform skip
if(current subblock does not use transform skip)
Signal the MTS transformkernel type (mts_idx) of the current subblock

On the other hand, replacing the step of signaling with parsing in Table 13 can make a pseudo code representing the parsing of syntax in terms of video decoding apparatus.

### <Implementation 2> Determining at a Higher Level Whether Both ISP and Transform Skip are to be Applied

In this implementation, the video encoding apparatus may determine at a higher level whether both ISP and transform skip are to be applied. As determined at the higher level, it is determined whether transform skip applies to subblocks within the ISP-enabled current block. The transform skip applies to subblocks within the ISP-enabled current block (Implementation 2-1) if the transform skip is enabled at the higher level, or (Implementation 2-2) if the use of both ISP and transform skip is enabled at the higher level.

### <Implementation 2-1> Applying Transform Skip to the ISP-Enabled Current Block if Transform Skip is Enabled at a Higher Level

In this implementation, to use both ISP and transform skip, the video encoding apparatus may apply transform skip to the ISP-enabled current block, if transform skip is enabled at a higher level. Because the subblocks within the ISP-enabled current block may each use transform skip if transform skip is enabled at the SPS level, the method of Implementation 1 may determine whether transform skip is to be used for each of the subblocks of the ISP-enabled current block. Whereas if transform skip is disabled at the SPS level, ISP may not be used. Example syntaxes with an improvement over the prior art with respect to this implementation are shown in Table 14.

TABLE 14

```
coding_unit( x0, y0, cbWidth, cbHeight, cqtDepth, treeType, modeType ) {
...
  if(sps_transform_skip_enabled_flag && sps_isp_enabled_flag &&
intra_luma_ref_idx = = 0 &&
    ( cbWidth <= MaxTbSizeY && cbHeight <= MaxTbSizeY ) &&
    ( cbWidth * cbHeight > MinTbSizeY * MinTbSizeY ) &&
        !cu_act_enabled_flag )
      intra_subpartitions_mode_flag
  if( intra_subpartitions_mode_flag = = 1 )
      intra_subpartitions_split_flag
...
```

### <Implementation 2-2> Applying Transform Skip to the ISP-Enabled Current Block, if the Use of Both ISP and Transform Skip is Enabled at a Higher Level

In this implementation, to use both ISP and transform skip, the video encoding apparatus may apply transform skip to the ISP-enabled current block, if the use of both ISP and transform skip is enabled at a higher level. In other words, the use of both ISP and transform is considered a kind of technique. The video encoding apparatus may use a high-level syntax in its own right to coordinate the use of ISP and transform combined. To indicate whether ISP and transform skip are enabled in unison at the SPS level, the video encoding apparatus may signal the sps_isp_transform_skip_enabled_flag. If both transform skip and ISP are enabled at the SPS level, i.e., sps_transform_skip_enabled_flag=1 and sps_isp_enabled_flag=1, the video encoding apparatus may signal sps_isp_transform_skip_enabled_flag as shown in Table 15.

```
TABLE 15
seq_parameter_set_rbsp( ) {
...
  sps_transform_skip_enabled_flag
...
  sps_isp_enabled_flag
    if(sps_transform_skip_enabled_flag = = 1 && sps_isp_enabled_flag = = 1)
      sps_isp_transform_skip_enabled_flag
...
```

Further, if sps_isp_transform_skip_enabled_flag=1, then for each subblock within the ISP-enabled current block, whether the transform skip is to be enabled and the transform kernel may be determined according to the method of Implementation 1.

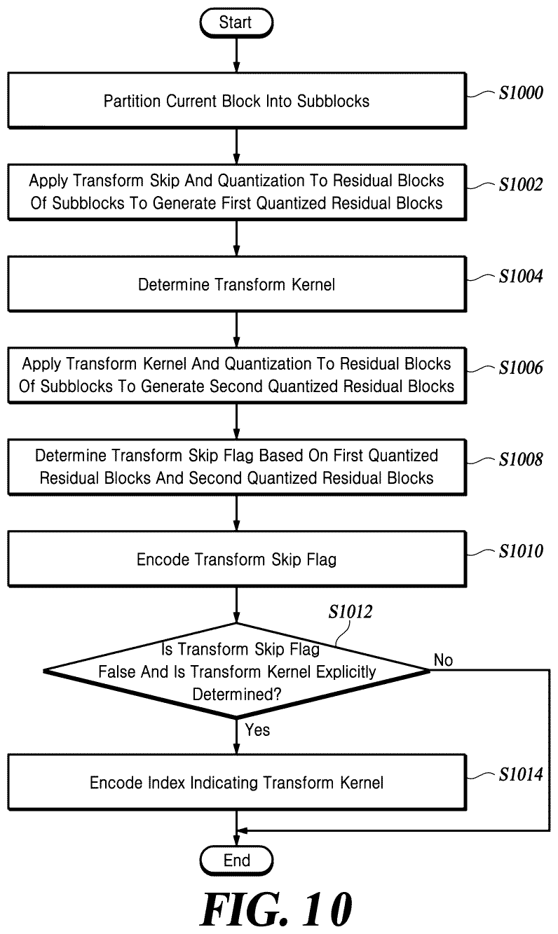

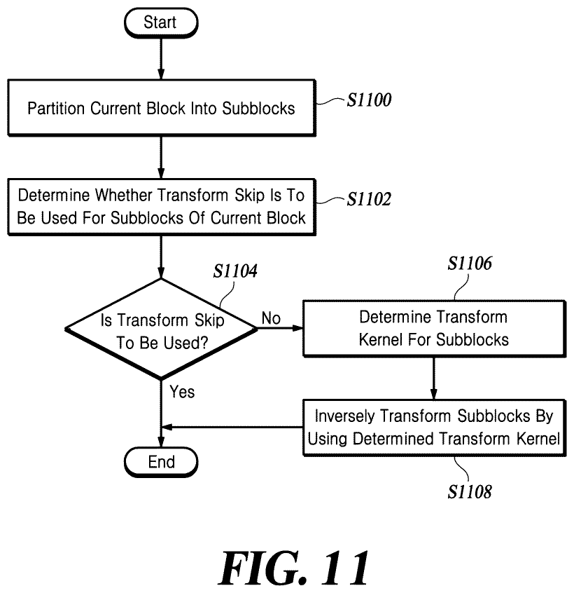

Referring now to FIGS. 10 and 11, methods of applying transform skip are described.

FIG. 10 is a flowchart of a method of encoding the current block by the video encoding apparatus, according to at least one embodiment of the present disclosure.

The video encoding apparatus partitions the current block into subblocks based on the size of the current block and the direction of the subblock partitioning (S1000). The video encoding apparatus may determine the size of the current block and the direction of the subblock partitioning of the current block, in terms of rate-distortion optimization.

The video encoding apparatus may apply a transform skip and quantization to the residual blocks of the subblocks to generate the first quantized residual blocks (S1002).

The video encoding apparatus may generate the residual blocks of the respective subblocks by subtracting, from the original subblock, the prediction blocks of the respective subblocks generated according to the intra prediction.

The video encoding apparatus determines a transform kernel (S1004).

The video encoding apparatus may implicitly derive the transform kernel. Alternatively, the video encoding apparatus may explicitly determine the transform kernel, in terms of optimizing the rate distortion.

The video encoding apparatus applies the transform kernel and quantization to the residual blocks of the subblocks to generate second quantized residual blocks (S1006).

The video encoding apparatus determines a transform skip flag based on the first quantized residual blocks and the second quantized residual blocks (S1008).

The video encoding apparatus may equally determine the transform skip flag for all subblocks of the current block based on the first quantized residual blocks and the second quantized residual blocks. In terms of rate-distortion optimization, the video encoding apparatus may determine the transform skip flag. For example, if the first quantized residual blocks are optimal, the transform skip flag may be determined to be true. In contrast, if second quantized residual blocks are optimal, the transform skip flag may be determined to be false.

As another example, the video encoding apparatus may determine the transform skip flag for each of the subblocks of the current block based on the first quantized residual blocks and the second quantized residual blocks. For example, if the first quantized residual block is optimal, the transform skip flag may be determined to be true for the relevant subblock. On the other hand, if the second quantized residual block is optimal, the transform skip flag may be determined to be false for the relevant subblock.

The video encoding apparatus encodes the transform skip flag (S1010).

When the transform skip flag is encoded for the respective subblocks, the video encoding apparatus may encode an array resulting from combining the transform skip flags for the respective subblocks. Alternatively, the video encoding apparatus may encode an index indicating one of the sets containing the transform skip flags for the respective subblocks.

The video encoding apparatus checks the transform skip flag and the transform kernel (S1012).

If the transform skip flag is false and the transform kernel is explicitly determined (Yes in S1012), the video encoding apparatus encodes an index indicating the transform kernel (S1014).

If the transform kernel is explicitly determined and applied equally to all subblocks of the current block, the video encoding apparatus may encode an index indicative of the transform kernel.

As another example, if the transform kernel for each subblock is explicitly determined and applied to each subblock, the video encoding apparatus may encode an index indicative of the transform kernel for each subblock.

On the other hand, if the transform skip flag is true (No in S1012), the transform is skipped, so the video encoding apparatus may skip the step of encoding the index indicative of the transform kernel.

Further, if the transform skip flag is false and the transform kernel is implicitly derived (No in S1012), the video encoding apparatus may skip the step of encoding the index indicative of the transform kernel.

FIG. 11 is a flowchart of a method of reconstructing the current block by the video decoding apparatus, according to at least one embodiment of the present disclosure.

The video decoding apparatus partitions the current block into subblocks based on the size of the current block and the direction of the subblock partitioning (S1100).

The video decoding apparatus may decode from the bitstream a size of the current block and a subblock partitioning direction of the current block.

The video decoding apparatus determines whether transform skip is to be used for the subblocks of the current block (S1102).

The video decoding apparatus decodes the transform skip flag from the bitstream. The video decoding apparatus may then equally determine, based on the decoded transform skip flag, whether transform skip is to be performed on all subblocks of the current block.

As another example, the video decoding apparatus decodes the transform skip flag for each subblock from the bitstream. The video decoding apparatus may then determine whether transform skip is to be used for each subblock based on the decoded transform skip flag. To decode the transform skip flags of the respective subblocks, the video decoding apparatus may decode an array resulting from combining the transform skip flags of the respective subblocks. Alternatively, the video decoding apparatus may decode an index indicating one of the sets containing the transform skip flags of the respective subblocks.

The video decoding apparatus determines whether transform skip is to be used (S1104).

If transform skip is used (Yes in S1104), the video decoding apparatus may generate residual blocks for the respective subblocks with the inverse transform skipped for the subblocks. The video decoding apparatus may then generate a reconstructed block of each subblock by summing the prediction block of each subblock and the residual block of the subblock.

On the other hand, if transform skip is not to be used (No in S1104), the following steps are performed.

The video decoding apparatus determines a transform kernel for the subblocks (S1106).

The video decoding apparatus may implicitly derive a transform kernel, and then determine the transform kernels of all subblocks to be the derived transform kernel. Alternatively, the video decoding apparatus may decode an index indicative of the transform kernel from the bitstream and determine the transform kernels of all subblocks to be the transform kernel indicated by the decoded index.

As another example, the video decoding apparatus may implicitly derive transform kernels for the respective subblocks, and then determine the transform kernels of the respective subblocks to be the derived transform kernel. Alternatively, the video decoding apparatus may decode an index indicative of the transform kernel of each subblock from the bitstream, and then determine the transform kernel of each subblock to be the transform kernel indicated by the decoded index.

The video decoding apparatus inversely transforms the subblocks by using the determined transform kernel (S1108).

The video decoding apparatus may inversely transform the subblocks to generate residual blocks of the respective subblocks. The video decoding apparatus may then generate reconstructed blocks of the respective subblocks by summing the prediction blocks of the respective subblocks and the inversely transformed subblocks to generate reconstructed blocks of the respective subblocks.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

122: intra predictor
140: transformer
165: inverse transformer
530: inverse transformer
542: intra predictor

1. A method of reconstructing a current block by a video decoding apparatus, the method comprising:
partitioning the current block into subblocks based on a size of the current block and a subblock partitioning direction;
determining whether a transform skip is to be used on the subblocks of the current block; and
checking whether the transform skip is used,
wherein the method further comprises, when the transform skip is not used:
determining a transform kernel for the subblocks.

2. The method of claim 1, further comprising, when the transform skip is not used:
inversely transforming the subblocks by using a determined transform kernel, and
wherein the method further comprises, when the transform skip is used:
skipping inversely transforming on the subblocks.

3. The method of claim 1, wherein determining whether the transform skip is to be used comprises:
decoding a transform skip flag from the bitstream; and
equally determining whether the transform skip is to be used for all subblocks of the current block based on the transform skip flag.

4. The method of claim 3, wherein determining the transform kernel comprises:
implicitly deriving the transform kernel; and
determining a derived transform kernel to be a transform kernel of all the subblocks.

5. The method of claim 3, wherein determining the transform kernel comprises:
decoding an index that indicates the transform kernel from the bitstream; and
determining a transform kernel indicated by the index to be a transform kernel of all the subblocks.

6. The method of claim 1, wherein determining whether the transform skip is to be used comprises:
decoding, from a bitstream, a transform skip flag for each of the subblocks; and
determining whether the transform skip is to be used for each of the subblocks based on the transform skip flag.

7. The method of claim 6, wherein decoding the transform skip flag comprises:
decoding an array of transform skip flags combined from a transform skip flag for each of the subblocks, or an index indicative of one of sets containing the transform skip flag for each of the subblocks.

8. The method of claim 6, wherein determining the transform kernel comprises:
implicitly deriving a transform kernel of each of the subblocks; and
determining a derived transform kernel to be a transform kernel of each of the subblocks.

9. The method of claim 6, wherein determining the transform kernel comprises:
decoding, from the bitstream, an index that indicates a transform kernel of each of the subblocks; and
determining a transform kernel indicated by the index to be a transform kernel of each of the subblocks.

10. A method of encoding a current block by a video encoding apparatus, the method comprising:
partitioning the current block into subblocks based on a size of the current block and a subblock partitioning direction;
generating first quantized residual blocks by applying a transform skip and a quantization to residual blocks of the subblocks;
implicitly deriving a transform kernel or explicitly determining the transform kernel; and
generating second quantized residual blocks by applying the transform kernel and the quantization to the residual blocks of the subblocks.

11. The method of claim 10, further comprising:
equally determining a transform skip flag for all subblocks of the current block based on the first quantized residual blocks and the second quantized residual blocks; and
encoding the transform skip flag.

12. The method of claim 11, further comprising:
checking the transform skip flag, and
wherein the method further comprises, when the transform skip flag is false and the transform kernel is explicitly determined and applied equally to all subblocks of the current block:
encoding an index that indicates the transform kernel.

13. The method of claim 10, further comprising:
determining a transform skip flag for each of the subblocks of the current block based on the first quantized residual blocks and the second quantized residual blocks; and
encoding the transform skip flag for each of the subblocks.

14. The method of claim 13, further comprising:
checking the transform skip flag, and
wherein the method further comprises, when the transform skip flag is false and a transform kernel of each of the subblocks is explicitly determined and applied to each of the subblocks:
encoding an index that indicates the transform kernel of each of the subblocks.

15. The method of claim 13, wherein encoding the transform skip flag comprises:
encoding an array of transform skip flags combined from a transform skip flag for each of the subblocks, or an index indicative of one of sets containing the transform skip flag for each of the subblocks.

16. A computer-readable recording medium storing a bitstream generated by a video encoding method, the video encoding method comprises:
partitioning a current block into subblocks based on a size of the current block and a subblock partitioning direction;
generating first quantized residual blocks by applying a transform skip and a quantization to residual blocks of the subblocks;
implicitly deriving a transform kernel or explicitly determining the transform kernel; and
generating second quantized residual blocks by applying the transform kernel and the quantization to the residual blocks of the subblocks.
